(19) United States
(12) Patent Application Publication
(10) Pub. No.: US 2005/0201742 A1
(43) Pub. Date: Sep. 15, 2005

(54) Blue tooth hard disk receiver

(76) Inventor: Chii-Moon Liou, Taipei Hsien (TW)

Correspondence Address: CHI-MOON LIOU, 235 P.O. BOX 10-69, Chung-Ho, TW

(21) Appl. No.: 10/795,834

(22) Filed: Mar. 9, 2004

(51) Int. Cl. G03B 7/00

(52) U.S. Cl. 396/211

(57) ABSTRACT

A blue tooth hard disk receiver comprises a first blue tooth module for receiving image data from an external device having a second blue tooth module; and a hard disk drive for storing image data transferred from the first blue tooth module. The blue tooth hard disk receiver further comprises a casing, a circuit board, a microprocessor, an IDE conversion interface, a USB interface, a power supply module and a battery. The data received by the blue tooth hard disk receiver is transferred to the hard disk drive through an IDE conversion interface. The blue tooth hard disk receiver is connected to a computer or a notebook computer through a USB interface. The first blue tooth module in the blue tooth hard disk receiver is connected to a third blue tooth module in one of a computer and a notebook computer so as to wirelessly transfer image data thereto.

### FIELD OF THE INVENTION

The present invention relates to blue tooth devices, and particular to a blue tooth hard disk receiver, wherein the capacity of the digital camera or digital video camera is increased so that a larger amount data can be stored. The data in the digital camera or digital video camera can be transferred wirelessly. The blue tooth hard disk receiver can be used to receive data from a plurality of digital video cameras or digital cameras. The blue tooth hard disk receiver can be used as a portable hard disk drive for replacing a low capacity memory card.

### BACKGROUND OF THE INVENTION

With reference to FIG. 1, in general, a digital camera 1 uses a memory card 10 for storing image data. Most of the image data are stored as JPG files in the memory card 10. However, the storage capacity of a digital camera is insufficient so that the image capturing operation must be interrupted due to insufficiency of memory space. This is especially for a digital video camera. Thereby, long period image capture can not be performed. Thereby, it is often that users must carry several memory cards 10. This induces a trouble to the users. Furthermore, if the image is dynamic, then the update of memory card 10 will cause that the user can not capture a desired image. Moreover, to many memory cards will induce a problem of management.

### SUMMARY OF THE INVENTION

Accordingly, the primary object of the present invention is to provide a blue tooth hard disk receiver, wherein the capacity of the digital camera or digital video camera is increased so that a larger amount data can be stored. The data in the digital camera or digital video camera is transferred wirelessly. The blue tooth hard disk receiver is used to receive data from a plurality of digital video cameras or digital cameras. The blue tooth hard disk receiver can be used as a portable hard disk drive for replacing a low capacity memory card. Thereby, the user is unnecessary to carry several memory cards.

To achieve above objects, the present invention provides a blue tooth hard disk receiver for wireless receiving and storing image data. The blue tooth hard disk receiver comprises a first blue tooth module for receiving image data from an external device having a second blue tooth module; and a hard disk drive for storing image data from the second blue tooth module. The blue tooth hard disk receiver further comprises a casing, a circuit board, a microprocessor, an IDE conversion interface, a USB interface, a power supply module and a battery. The data received by the blue tooth hard disk receiver is transferred to the hard disk drive through an IDE conversion interface. The blue tooth hard disk receiver is connected to one of a computer and a notebook computer through a USB interface; and data in the hard disk drive is transferred to the computer or the notebook computer through the USB interface. Moreover, The first blue tooth module in the blue tooth hard disk receiver is connected to a third blue tooth module in one of a computer and a notebook computer so as to wirelessly transfer image data to the computer or the notebook computer.

The various objects and advantages of the present invention will be more readily understood from the following detailed description when read in conjunction with the appended drawing.

### BRIEF DESCRIPTION OF THE DRAWINGS

FIG. 1 shows the prior art memory card structure.

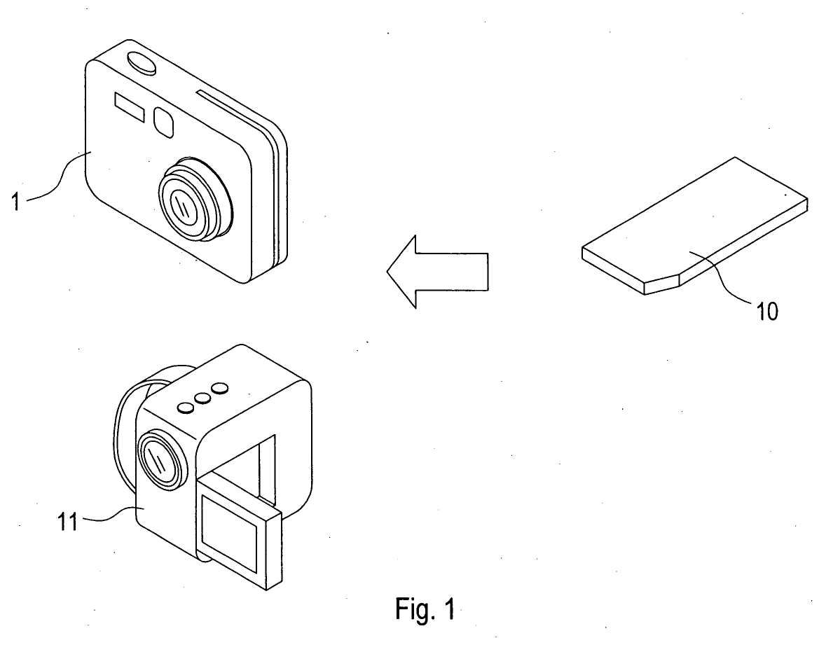

FIG. 2 is a structure block diagram of the circuit board of the blue tooth hard disk receiver of the present invention.

FIG. 3 is an exploded view of the blue tooth hard disk receiver of the present invention.

FIG. 4 is an assembled view of the blue tooth hard disk receiver of the present invention.

FIG. 5 shows one application of the blue tooth hard disk receiver of the present invention.

FIG. 6 shows another application of the USB interface according to the present invention.

FIG. 7 shows a further application of the blue tooth device of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

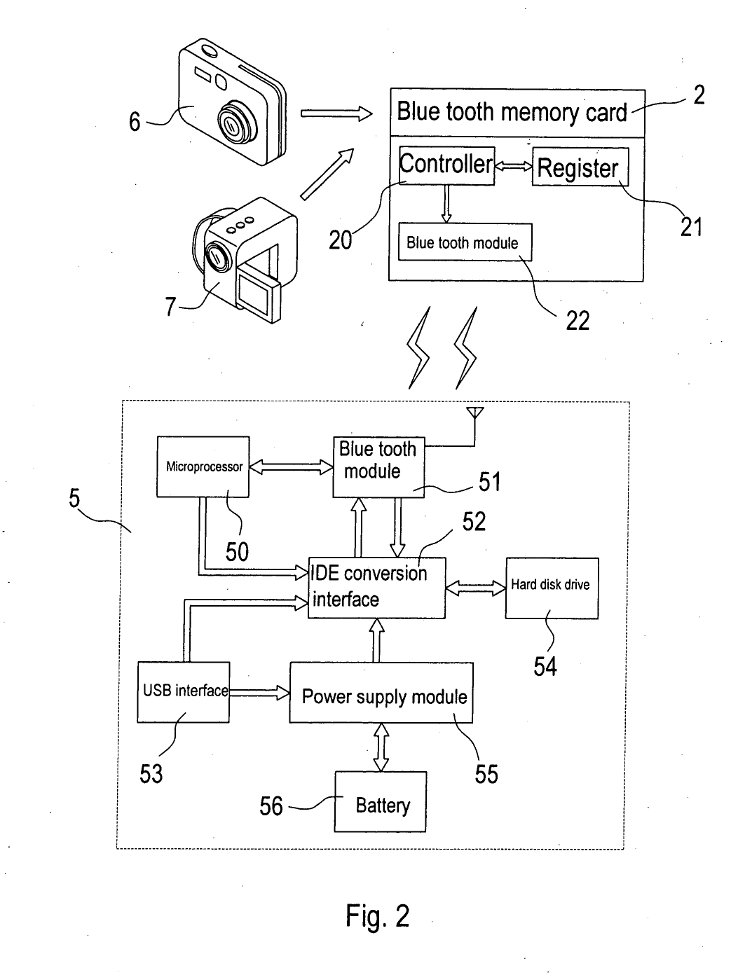

With reference to FIG. 2, the blue tooth hard disk receiver of the present invention is illustrated. The blue tooth hard disk receiver 3 is wirelessly connected to a blue tooth memory card 2. The blue tooth hard disk receiver 3 comprises a casing 4, a circuit board 5, a microprocessor 50, a blue tooth module 51, an IDE conversion interface 52, a USB interface 53, a hard disk drive 54, a power supply module 55 and a battery 56.

The blue tooth memory card 2 includes a controller 20, a register 21 and a blue tooth memory card 2. A digital camera 6 or a digital video camera 7 is connected to a blue tooth memory card 2. Image data is transferred from the digital camera 6 or the digital video camera 7 to the blue tooth memory card 2. Thereby, the image data is stored in the register 21 through the controller 20. A protocol of the blue tooth module 22 of the blue tooth memory card 2 is identical to that of the blue tooth hard disk receiver 3. The blue tooth hard disk receiver 3 serves to receive image data transmitted from the blue tooth memory card 2.

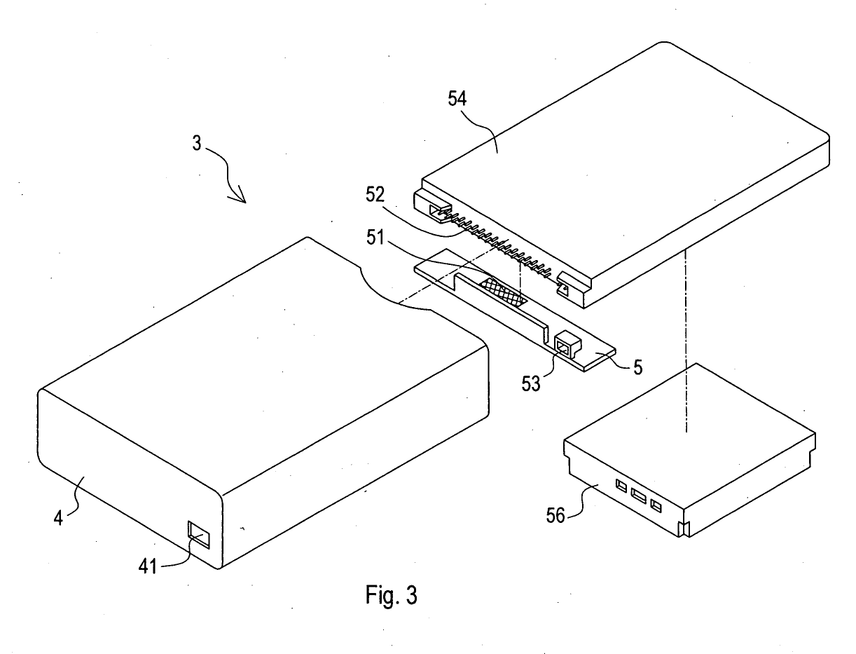

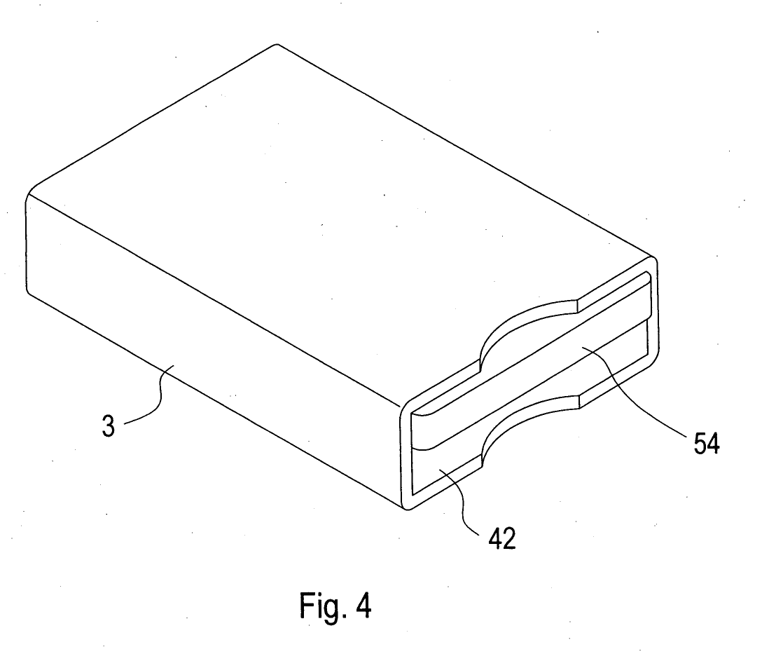

Referring to FIGS. 3 and 4, the blue tooth hard disk receiver 3 includes a casing 4 and a circuit board 5. The circuit board 5 is installed within the casing 4. The casing 4 has a groove 40. The groove 40 is formed with a via hole 41. An USB interface 53 at a lower lateral side of the circuit board 5 is arranged corresponding to the via hole 41. One end of the casing 4 is formed with a slot 42 for receiving the hard disk drive 54. The circuit board 5 includes a power supply module 55. The power supply module 55 is capable of being connected to a battery 56. An IDE conversion interface 52 is installed on the circuit board 5. When the hard disk drive 54 is received in the slot 42, the IDE conversion interface 52 is connected to the hard disk drive 54. The microprocessor 50 serves to transfer image data received from the blue tooth module 51 to the hard disk drive 54.

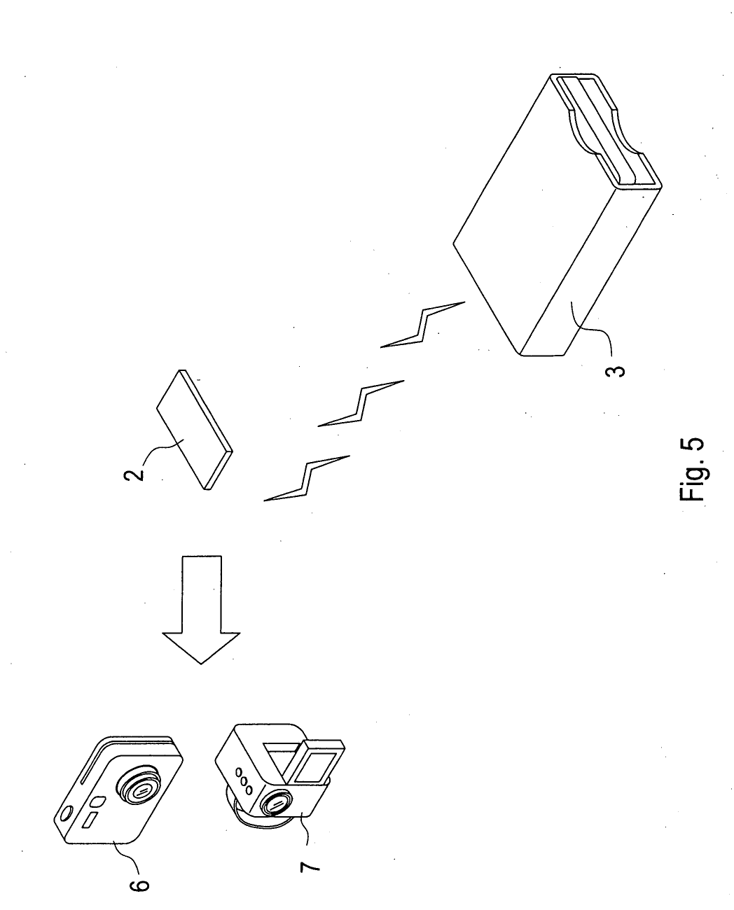

With reference to FIG. 5, in the present invention, when the digital camera 6 or the digital video camera 7 captures images. The data is stored in the blue tooth memory card 2. The controller 20 of the blue tooth memory card 2 will determine automatically whether the blue tooth connection works. If yes, the data in the blue tooth memory card 2 will be transferred to the hard disk drive 54 through the blue tooth module 51. If not, the image data is stored in the register 21 of the blue tooth memory card 2 and when the connection is successful, the data will be transferred to the blue tooth hard disk receiver 3 and then is stored in the hard disk drive 54. Then, the data in the register 21 is cleared.

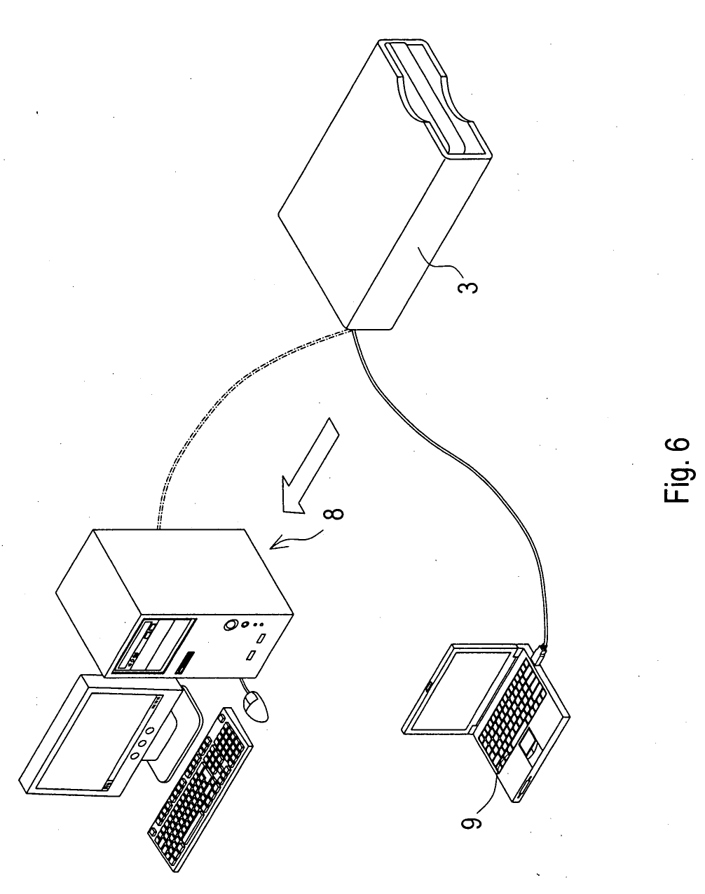

With reference to FIG. 6, the present invention provides the USB interface 53 for connecting to a computer 8 or a notebook computer 9. Through the USB interface 53, the data stored in the hard disk drive 54 is transferred to the computer 8 or the notebook computer 9. Moreover, at the same time, the USB interface 53 can clear the data stored in the hard disk drive 54 so that the hard disk drive 54 has more capacity.

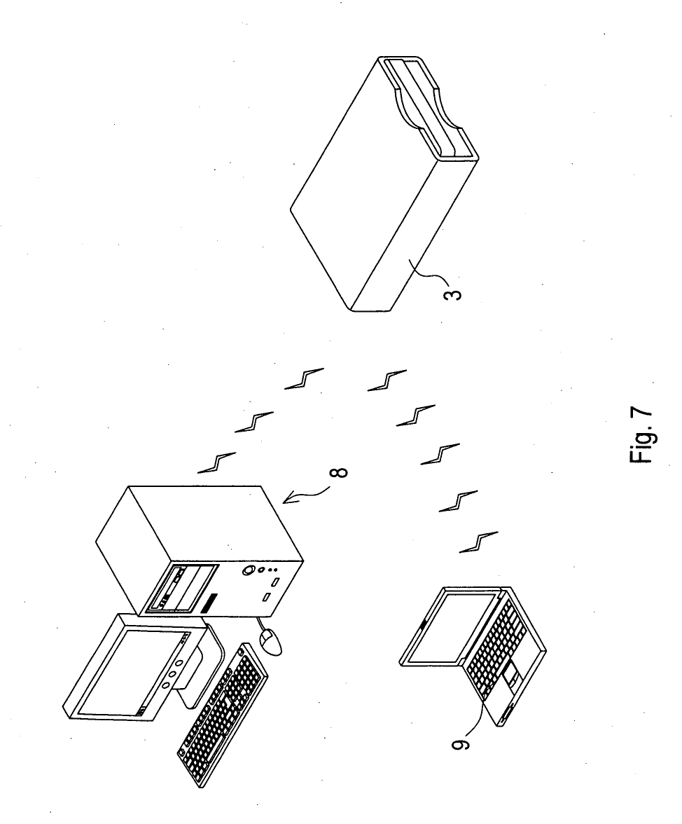

With reference to FIG. 7, the blue tooth module 51 of the blue tooth hard disk receiver 3 is wirelessly connected to that of the computer 8 or the notebook computer 9. Thereby, data can be transferred to the computer 8 or the notebook computer 9.

Advantages of the present invention will be described here. The present invention increases the capacity of the digital camera or digital video camera so that a larger amount data can be stored. By using the present invention, the data in the digital camera or digital video camera is transferred wirelessly. One blue tooth hard disk receiver can be used to receive data from a plurality of digital video cameras or digital cameras. The blue tooth hard disk receiver of the present invention is as a portable hard disk drive for replacing a low capacity memory card. Thereby, the user is unnecessary to carry several memory cards.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A blue tooth hard disk receiver for wireless receiving and storing image data; the blue tooth hard disk receiver comprising:
a first blue tooth module for receiving image data from an external device having a second blue tooth module; and
a hard disk drive for storing image data transferred from the first blue tooth module.

2. The blue tooth hard disk receiver as claimed in claim 1, wherein the external device is a blue tooth memory card.

3. The blue tooth hard disk receiver as claimed in claim 1, wherein the blue tooth hard disk receiver further comprises a casing, a circuit board, a microprocessor, an IDE conversion interface, a USB interface, a power supply module and a battery.

4. The blue tooth hard disk receiver as claimed in claim 1, wherein the data received by the blue tooth hard disk receiver is transferred to the hard disk drive through an IDE conversion interface.

5. The blue tooth hard disk receiver as claimed in claim 1, wherein the blue tooth hard disk receiver is connected to one of a computer and a notebook computer through a USB interface; data in the hard disk drive is transferred to the computer or the notebook computer through the USB interface.

6. The blue tooth hard disk receiver as claimed in claim 5, wherein the data in the hard disk drive is cleared by the USB interface.

7. The blue tooth hard disk receiver as claimed in claim 1, wherein the first blue tooth module in the blue tooth hard disk receiver is connected to a third blue tooth module in one of a computer and a notebook computer so as to wirelessly transfer image data to the computer or the notebook computer.
